(19) United States
(12) Patent Application Publication
(10) Pub. No.: US 2020/0165148 A1
(43) Pub. Date: May 28, 2020

(54) A METHOD USING PHOTOCATALYTIC ELECTRODE COUPLED WITH MICROBIAL FUEL CELL TO PROMOTE TREATMENT OF COKING WASTEWATER

(71) Applicant: Dalian University of Technology, Dalian City (CN)

(72) Inventors: Lifen LIU, Dalian City (CN); Jing ZHOU, Dalian City (CN); Jing SHI, Dalian City (CN)

(21) Appl. No.: 16/478,104

(22) PCT Filed: Jun. 20, 2018
(86) PCT No.: PCT/CN2018/091910

§ 371 Date: Jul. 15, 2019

(30) Foreign Application Priority Data
May 22, 2018 (CN) 201810530810.6

(51) Int. Cl. C02F 1/461; C02F 1/30; C02F 3/00; H01M 8/16

(52) U.S. Cl. CPC C02F 1/46109; C02F 1/30; C02F 2101/30; H01M 8/16; C02F 2001/46142; C02F 3/005

(57) ABSTRACT

A method of promoting the treatment of coking wastewater using photocatalytic electrode coupled with microbial fuel cellin the technical field of coking wastewater treatment, energy-saving and resource utilization. La-ZnIn₂S₄/RGO/BiVO₄ and silica sol were fixed and coated on stainless steel mesh to form conductive catalytic composite membrane electrode. HSO₃⁻was added to coking wastewater. Graphite Carbon rods are inserted into the anodic chamber with microorganisms and connected the cathode with wires to form circuit loops. Halogen tungsten lamp was applied as light source to act on the catalytic electrode, forming a coupled system with photocatalytic electrode and microbial fuel cell for treating coking wastewater. The effects of La-ZnIn₂S₄/RGO/BiVO₄ catalysts with different RGO contents on the catalytic degradation of coking wastewater were realized, and the effects of NaHSO₃ and Na₂SO₄ solutions at the same concentration on the degradation of coking wastewater were also realized.

### TECHNICAL FIELD

The invention belongs to the technical field of coking wastewater treatment, energy-saving and resource utilization. It is about the preparation of La-ZnIn₂S₄/RGO/BiVO₄ composite catalyst, photocatalytic electrode coupled with microbial fuel cell module, and its synergistic effect. In the reaction process, HSO₃⁻was added to treat coking wastewater. HSO₃⁻is helpful to improve the degradation rate of coking wastewater and promote the treatment of coking wastewater.

### BACKGROUND

Coking wastewater is mainly produced by coal industry and petroleum industry. It is a kind of industrial organic wastewater which is difficult to be treated. It is produced in the process of high temperature distillation at 960-1000 degrees Celsius and during purification of coking gas. Its composition is very complex, including sulfide, cyanide, high concentration of ammonia nitrogen and a large number of toxic and harmful compounds such as heterocyclic polycyclic aromatic hydrocarbons, which are difficult to be biodegraded. Different treatment methods (physicochemical treatment method, biochemical treatment method, photocatalytic oxidation technology, Fenton reagent method, catalytic wet oxidation, etc.) have their own limitations while they are used in pollutants degradation. At present, the application of La-ZnIn₂S₄/RGO/BiVO₄ ternary composite catalyst in photocatalytic microbial fuel cell for degradation of coking wastewater has not been reported.

In order to improve the degradation effect of coking wastewater, the photocatalyst La-ZnIn₂S₄/RGO/BiVO₄ was introduced into the photocatalytic microbial fuel cell reactor to achieve the purpose. At present, using La-ZnIn₂S₄/RGO/BiVO₄ as catalyst, combining photocatalytic technology with microbial fuel cell technology, the organic pollutant in coking wastewater is degraded to a great extent, which is of great significance in coking wastewater treatment.

At present, there are two kinds solid-state electronic mediators, that have been proved promising for light excitation and charge generation. There are precious metals and Reduced Graphene Oxide (RGO). Flake RGO materials provide better morphological diversity and lower preparation cost than precious metals due to their specific layered structure and chemical stability.

In addition, bismuth vanadate (BiVO₄) has been proved to be a promising photocatalyst because of its narrow band gap and wide wavelength response range. BiVO₄ has three crystal types: monoclinic scheelite, tetragonal zircon and tetragonal scheelite. Among them, monoclinic scheelite has a narrow band-gap energy (2.4 eV), which can respond to both ultraviolet and visible light and show good photocatalytic activity. In previous studies, in order to improve charge separation efficiency and adjust the interaction between BiVO₄ and substrate, various metal salts (such as AgNO₃, Cu (NO₃)₂, Ni (NO₃)₂, RuCl₃, PdCl₂, etc.) were supported on the surface of BiVO₄ as promoters to improve its photocatalytic efficiency. RGO electronic mediators can be easily extended to semiconductor-based composite photocatalytic systems. BiVO₄ treated with RGO exhibits unique activity in photocatalytic oxidation of water and degradation of organic pollutants.

ZnIn₂S₄, which belongs to AB_{X}C_{Y} type semiconductor ternary sulfide, has been widely praised for its narrow band gap, strong photocatalytic performance, large specific surface area and good adsorption performance in the degradation of dye wastewater and photocatalytic decomposition of water for hydrogen production. The charge separation can be effectively improved by heterostructures formed by coupling different catalysts. Coupling photocatalysts with different absorption wavelength ranges can increase their wavelength absorption range, thereby improving photocatalytic efficiency.

In this application, La-ZnIn₂S₄/RGO/BiVO₄ was used as the experimental catalyst. It was hoped that this catalyst can effectively degrade coking wastewater in order to achieve the effect of adsorbing and degrading organic pollutants in coking wastewater.

### SUMMARY

The invention designs a La-ZnIn₂S₄/RGO/BiVO₄ photocatalytic microbial fuel cell module, and successfully constructs a photocatalytic electrode coupled microbial fuel cell system. The system not only can be used as an electrode, but also has photocatalytic and conductive effects. The overall efficiency of coking wastewater treatment is greatly improved, energy consumption is low, and the concentration of organic pollutants in coking wastewater is greatly reduced. The system can degrade coking wastewater theoretically, expand the application of supported photocatalyst, and provide some ideas for treating other wastewater.

The technical details of the present invention:

The steps of using photocatalytic electrode and coupled microbial fuel cell system to degrade coking wastewater are as follows:

(1) The preparation of the series of La-ZnIn₂S₄/RGO/BiVO₄ composites: Bi(NO₃)₃.5H₂O was dissolved in 14 wt % HNO₃, stirred it, and then added CTAB solution into it. Controlling the mass ratio of CTAB to Bi(NO₃)₃.5H₂O at 1:15 then adding GO and stirring the solution to obtain mixed solution A;

NH₄VO₃ was dissolved in 2 mol/L NaOH solution and added to liquid A drop by drop. The molar ratio of NH₄VO₃ to Bi(NO₃)₃. 5H₂O in liquid A was 1:1; 2 mol/L NaOH solution was used to adjust pH=6; stirring the solution; The mixture was obtained by reaction at 200° C. for 2 h and cooling; After washing, centrifuging, drying, grinding, x RGO/BiVO₄ was obtained, grinding it to powder, xRGO/BiVO₄ was obtained; X meant mass ratio of RGO to BiVO₄ in RGO/BiVO₄ is less than 1.5%.

Zn(NO₃)₃.6H₂O, In(NO₃)₃.5H₂O and excessive TAA were dissolved in deionized water, then La(NO₃)₃ and RGO/BiVO₄ were added to the deionized water. Stirring the solution. The mixture was prepared by reaction for 6 h at 80° C. After centrifugation, drying and grinding, yLa-ZnIn₂S₄/xRGO/BiVO₄ was obtained, which was ground into powder, i.e. yLa-ZnIn₂S₄/xRGO/BiVO₄; Among them, the mass ratio of La-ZnIn₂S₄ to RGO/BiVO₄ is 1:5, and Y is 0.01 for La and ZnIn₂S₄;

(2) Preparation of photocatalytic electrode-coupled microbial fuel cell membrane module: Adding silica sol into yLa-ZnIn₂S₄/xRGO/BiVO₄ series composites prepared in step (1), the ratio of yLa-ZnIn₂S₄/xRGO/BiVO₄ series composite to silica sol was 1 g:1 μL. Homogenizing it by ultrasonic, and coating it on stainless steel mesh and drying it;

(3) Construction of photocatalytic electrode-coupled microbial fuel cell membrane catalytic treatment system: The system was divided into two chambers by proton exchange membrane, in which microorganisms were placed in one chamber and graphite carbon rods were inserted as anodes; Coking wastewater contained NaHSO₃ was put in the other chamber, photocatalytic electrode-coupled microbial fuel cell membrane module made in Step (2) was prepared as cathodes; Placing halogen-tungsten lamp in the second chamber, which was connected by wires to form a circuit. Halogen tungsten lamp vertical irradiated the photocatalytic electrode, coupled with microbial fuel cell membrane module.

Beneficial effects of the present invention are as follows: the system integrates the electricity generation performance of photocatalytic membrane electrodes and microbial fuel cells, and their coupling synergistic effects to adsorb and degrade organic pollutants in coking wastewater; the refractory organic pollutants in coking wastewater can be effectively adsorbed and degraded; the photo catalysts and microorganisms in the system can well be ensured that they do not lose their activity, maintain their activity so they can continued generate electricity.

### DESCRIPTION OF DRAWINGS

FIG. 1 is a comparison figure of the degradation of coking wastewater under the coupling system of photocatalytic electrode and microbial fuel cell with the same concentration of NaHSO₃ and different RGO content in La-ZnIn₂S₄/RGO/BiVO₄ catalyst. In the figure, the abscissa is time (h), and the ordinate is TOC degradation efficiency (%) of coking wastewater.

FIG. 2 is a comparison of degradation of coking wastewater by adding the same concentration of NaHSO₃ and Na₂SO₄ in the cathodic coking wastewater under the coupling system of photocatalytic electrode and microbial fuel cell. In the figure, the abscissa is time (h), and the ordinate is TOC degradation efficiency (%) of coking wastewater.

### SPECIFIC IMPLEMENTATION METHODS

Specific implementation methods of the present invention are described in detail below in connection with the technical scheme and the accompanying drawings.

### Implementation Example 1: Degradation of Coking Wastewater by Catalysts with Different RGO Contents

In the two-chamber cuboid reactor system of photocatalytic membrane electrode coupled with microbial fuel cell, the membrane module and halogen tungsten lamp are put into the system, and carbon rods are put into the microbial anode separated by proton exchange membrane. The coking wastewater containing NaHSO₃ in the photocatalytic system is in the photo cathode. The aerator is continuously aerated at the bottom of the cathode chamber. The top of the membrane was connected with a crocodile clamp. The halogen tungsten lamp is put into the reaction device. The halogen tungsten lamp is power-off before reaction. After in dark reaction for 0.5 h, the power supply of halogen tungsten lamp is turned on for 4 h. After reaction begins, samples were taken with pipette every 0.5 hours in the first 2.5 hours, and every 1.0 hours in the next two hours. The reaction lasts 4.5 hours. The TOC content in the samples was detected by TOC/TN detector, and the degradation effect of organic pollutants in coking wastewater was calculated.

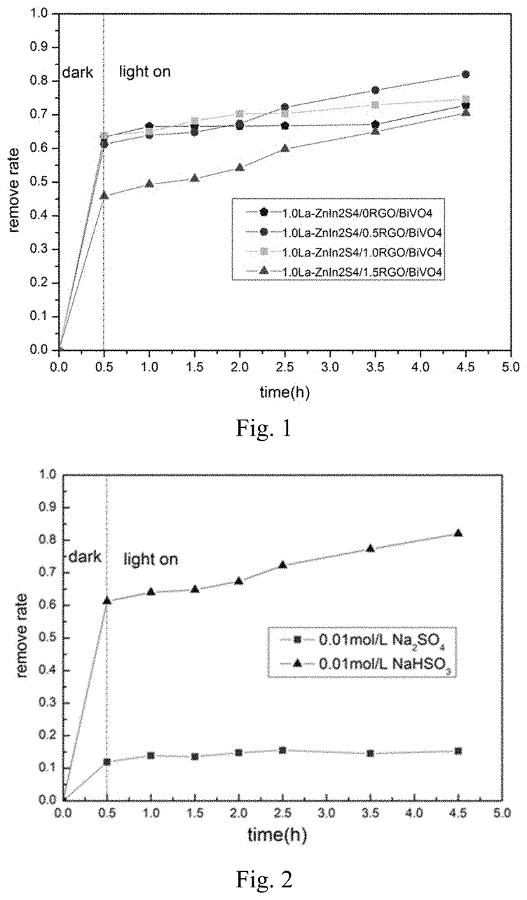

In FIG. 1, 0.5% RGO had the best degradation effect, which was 82.02%.

### Implementation Example 2: Degradation of Coking Wastewater by Systems Containing NaHSO₃ and Na₂SO₄ of the Same Concentration

In the two-chamber cuboid reactor system of photocatalytic membrane electrode coupled with microbial fuel cell, the membrane module and halogen tungsten lamp are put into the system. Carbon rods are put into the microbial anode separated by proton exchange membrane. One is the coking wastewater containing NaHSO₃ in the photocatalytic system as photo-electrochemical cathode (the other is the coking wastewater containing Na₂SO₄ in the photocatalytic system as photo-electrochemical cathode, other conditions are the same.) The aerator is continuously aerated at the bottom of the cathode chamber. The top of the membrane was connected with a crocodile clamp. The halogen tungsten lamp is put into the reaction device. Before the reaction, the power of halogen tungsten lamp is turned off After the dark reaction for 0.5 hours, the halogen tungsten lamp power is turned on for 4 hours. After the reaction starts, samples were taken with pipette every 0.5 hours in the first 2.5 hours, and the second two hours are sampled every 1.0 hours. The reaction lasts for 4.5 hours. TOC content in samples was detected by TOC/TN detector, and the degradation effect of organic pollutants in coking wastewater was calculated.

In FIG. 2, coking wastewater containing NaHSO₃ was compared with coking wastewater containing Na₂SO₄. It was found that the degradation efficiency of coking wastewater containing NaHSO₃ in the system of photocatalytic membrane electrode coupled with microbial fuel cell (82%) was much better than that of coking wastewater containing Na₂SO₄ (15%).

1. A method using photocatalytic electrode coupled with microbial fuel cell to promote treatment of coking wastewater, wherein it has the following steps:
(1) the preparation of the series of La-ZnIn₂S₄/RGO/BiVO₄ composites: Bi(NO₃)₃.5H₂O was dissolved in 14 wt % HNO₃, stirred it, and then added CTAB solution into it; controlling the mass ratio of CTAB to Bi(NO₃)₃.5H₂O at 1:15 then adding GO and stirring the solution to obtain mixed solution A;
NH₄VO₃ was dissolved in 2 mol/L NaOH solution and added to liquid A drop by drop; the molar ratio of NH₄VO₃ to Bi(NO₃)₃.5H₂O in liquid A was 1:1; 2 mol/L NaOH solution was used to adjust pH=6; stirring the solution; the mixture was obtained by reaction at 200° C. for 2 h and cooling; after washing, centrifuging, drying, grinding, x RGO/BiVO₄ was obtained, grinding it to powder, xRGO/BiVO₄ was obtained; X meant mass ratio of RGO to BiVO₄ in RGO/BiVO₄ is less than 1.5%;
Zn(NO₃)₃6H₂O, In(NO₃)₃.5H₂O and excessive TAA were dissolved in deionized water, then La(NO₃)₃ and RGO/BiVO₄ were added to the deionized water; stirring the solution; the mixture was prepared by reaction for 6 h at 80° C.; after centrifugation, drying and grinding, yLa-ZnIn₂S₄/xRGO/BiVO₄ was obtained, which was ground into powder, i.e. yLa-ZnIn₂S₄/xRGO/BiVO₄; among them, the mass ratio of La-ZnIn₂S₄ to RGO/BiVO₄ is 1:5, and Y is 0.01 for La and ZnIn₂S₄;
(2) preparation of photocatalytic electrode-coupled microbial fuel cell membrane module: adding silica sol into yLa-ZnIn₂S₄/xRGO/BiVO₄ series composites prepared in step (1), the ratio of yLa-ZnIn₂S₄/xRGO/BiVO₄ series composite to silica sol was 1 g: 1 μL; homogenizing it by ultrasonic, and coating it on stainless steel mesh and drying it;
(3) construction of photocatalytic electrode-coupled microbial fuel cell membrane catalytic treatment system: the system was divided into two chambers by proton exchange membrane, in which microorganisms were placed in one chamber and carbon rods were inserted as anodes; coking wastewater contained NaHSO₃ was put in the other chamber, photocatalytic electrode-coupled microbial fuel cell membrane module made in step (2) was prepared as cathodes; placing halogen-tungsten lamp in the second chamber, which was connected by wires to form a circuit; halogen tungsten lamp vertical irradiated photocatalytic electrode coupled with microbial fuel cell membrane module.

2. The photocatalytic electrode coupled with the microbial fuel cell described in claim 1, wherein the pollutant is organic pollutant in coking wastewater.
